(19) United States
(12) Patent Application Publication
(10) Pub. No.: US 2024/0145129 A1
(43) Pub. Date: May 2, 2024

(54) CABLE

(71) Applicant: SUMITOMO ELECTRIC INDUSTRIES, LTD., Osaka (JP)

(72) Inventors: Jun OTSUKA, Tochigi (JP); Atsuko SHINOMIYA, Tochigi (JP); Yuko YAMAGUCHI, Tochigi (JP); Ryota NAKANO, Tochigi (JP); Syota MACHINAKA, Osaka (JP)

(21) Appl. No.: 18/480,045

(22) Filed: Oct. 3, 2023

(30) Foreign Application Priority Data
Oct. 31, 2022 (JP) 2022-174732

(51) Int. Cl. H01B 11/10

(52) U.S. Cl. CPC H01B 11/10

(57) ABSTRACT

A cable includes a twisted pair electrical wire having a pair of electrical wires twisted together, and a dielectric covering the twisted pair electrical wire. A dielectric loss tangent of the dielectric is greater than 2.5×10⁻⁴.

### CROSS-REFERENCE TO RELATED APPLICATIONS

This application is based upon and claims priority to Japanese Patent Application No. 2022-174732, filed on Oct. 31, 2022, the entire contents of which are incorporated herein by reference.

### TECHNICAL FIELD

The present disclosure relates to cables.

### BACKGROUND

As an example, Japanese Laid-Open Patent Publication No. 2020-17436 describes a twisted pair cable including a pair of electrical wires twisted together, wherein the electrical wires have a plurality of kinds of twist pitches.

In recent years, cables used for communication are required to reduce conversion from a common mode to a differential mode due to transmission, from a viewpoint of reducing generation of communication errors and stabilizing the communication.

### SUMMARY

A cable according to one aspect of the present disclosure includes a twisted pair electrical wire having a pair of electrical wires twisted together; and a dielectric covering the twisted pair electrical wire, wherein a dielectric loss tangent of the dielectric is greater than 2.5×10⁻⁴.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF THE DRAWINGS

FIG. 1 is a cross sectional view of a cable according to one aspect of the present disclosure, along a plane perpendicular to a longitudinal direction of the cable; and

FIG. 2 is a diagram illustrating rates of change of attenuation of a differential mode signal and a common mode signal when a dielectric loss tangent of a dielectric is varied.

### DETAILED DESCRIPTION

One object according to one aspect of the present disclosure is to provide a cable capable of reducing conversion from the common mode to the differential mode.

A description will hereinafter be given of embodiments of the present disclosure, with reference to the drawings.

### Description of Embodiments of the Present Disclosure

First, embodiments of the present disclosure will be described. In the following description, the same or corresponding elements are designated by the same reference numerals, and repeated description thereof may be omitted.

(1) A cable according to the present disclosure includes a twisted pair electrical wire having a pair of electrical wires twisted together, and a dielectric covering the twisted pair electrical wire, wherein a dielectric loss tangent of the dielectric is greater than 2.5×10⁻⁴.

The present inventors studied extents of attenuation of common mode signals and differential mode signals for a case where the dielectric loss tangent of the dielectric is varied in the cable including the twisted pair electrical wire and the dielectric covering the twisted pair electrical wire. As a result, it was found that, as the dielectric loss tangent of the dielectric increases, the attenuation increases for both the common mode signals and the differential mode signals. However, a rate of change of the attenuation associated with the variation of the dielectric loss tangent was greater for the common mode signals than for the differential mode signals.

According to the studies conducted by the present inventors, the extent of the attenuation of the common mode signals can be particularly increased by setting the dielectric loss tangent of the dielectric to a value greater than 2.5×10⁻⁴, thereby enabling the common mode signals to be selectively attenuated.

For this reason, by setting the dielectric loss tangent of the dielectric to the value greater than 2.5×10⁻⁴, it is possible to reduce the signal generated by the mode conversion, particularly the common mode signal, and to sufficiently reduce the conversion from the common mode to the differential mode.

(2) In the cable according to (1) above, a jacket may be disposed on an outer side of the dielectric.

When the cable of the present disclosure includes the jacket, the twisted pair electrical wire or the like disposed in an interior can be protected, and a durability of the cable can be improved.

(3) In the cable according to (2) above, a shielding layer made of a metal, may be disposed between the dielectric and the jacket.

Because the cable of the present disclosure includes the shielding layer, it is possible to shield external noise from entering the electrical wires, and to shield noise from being emitted to the outside from the electrical wires.

(4) In the cable according to any one of (1) to (3) above, each of the pair of electrical wires may include a conductor, and an insulator covering the conductor, and the dielectric loss tangent of the dielectric may be greater than a dielectric loss tangent of the insulator.

By setting the dielectric loss tangent of the dielectric to a value greater than the dielectric loss tangent of the insulator, it is possible to reduce the conversion from the common mode to the differential mode, while reducing a transmission loss of the electrical wires of the twisted pair electrical wire.

### Details of Embodiments of the Present Disclosure

Specific examples of a cable according to one embodiment of the present disclosure (hereinafter referred to as “the present embodiment”) will be described below, with reference to the drawings. The present invention is not limited to these examples, and is intended to include what is defined in the claims, and all modifications within the meaning and scope equivalent to the scope of claims.

[Cable]

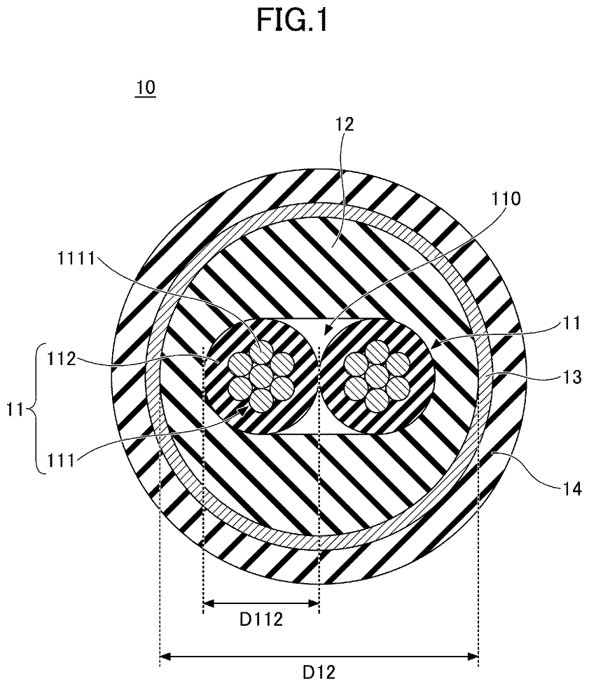

FIG. 1 illustrates a configuration example of a cross section perpendicular to a longitudinal direction of the cable according to the present embodiment. A direction perpendicular to a paper surface in FIG. 1 corresponds to the longitudinal direction of the cable.

As illustrated in FIG. 1, a cable 10 according to the present embodiment includes a twisted pair electrical wire 110 having a pair of electrical wires 11 twisted together, and a dielectric 12 covering the twisted pair electrical wire 110.

(1) Each Member Included in Cable:

Each member included in the cable 10 according to the present embodiment will be described.

(1-1) Electrical Wire:

The electrical wire 11 includes a conductor 111, and an insulator 112 covering the conductor 111.

(Conductor)

A material used for the conductor 111 is not particularly limited, and for example, one or more conductive materials selected from copper alloys, copper, silver plated annealed copper, and tin plated annealed copper can be used for the conductor 111. Annealed copper can be suitably used as the copper.

The conductor 111 can be a single wire or a stranded wire. From a viewpoint of improving flexibilities (or bending ease) of the electrical wire 11, and the cable 10 including the electrical wires 11, the conductor 111 is preferably a stranded wire having a plurality of conductor element wires 1111 twisted together.

(Insulator)

As illustrated in FIG. 1, the insulator 112 can cover an outer surface of the conductor 111, more particularly, the outer surface along the longitudinal direction of the conductor 111.

A material used for the insulator 112 is not particularly limited. The insulator 112 can include a resin material. The resin material included in the insulator 112 is not particularly limited, and for example, one or more kinds of resins selected from a polyolefin-based resin, a polyvinyl chloride resin (PVC), a thermoplastic elastomer (TPE), or the like can be suitably used as the resin material.

The polyolefin-based resin is not particularly limited. For example, examples of the polyolefin-based resin include polyethylene (PE), ethylene-acrylic ester copolymers, such as polypropylene (PP), ethylene-vinyl acetate copolymer (EVA), ethylene-ethyl acrylate copolymer (EEA), or the like, ethylene α-olefin copolymer, ethylene-methyl acrylate copolymer, ethylene-butyl acrylate copolymer, ethylene-methyl methacrylate copolymer, ethylene-acrylic acid copolymer, partially saponified EVA, maleic anhydride-modified polyolefin, ethylene-acrylic ester maleic anhydride copolymer, or the like. Each of these resins can be used by itself, or two or more kinds of resins can be used in combination.

The resin material used for the insulator 112 can be cross-linked, or not cross-linked.

The insulator 112 can include an additive, such as a flame retardant, a flame retardant assistant, an antioxidant, a lubricant, a coloring agent, a reflection imparting agent, a masking agent, a processing stabilizer, a plasticizer, or the like.

A shape and a size of the insulator 112 are not particularly limited. The insulator 112 can have a circular shape in a cross section perpendicular to the longitudinal direction, as illustrated in FIG. 1. The term “circular shape” as used herein does not have a geometrically strict meaning, and includes circular shapes other than a perfect circle, such as an oval shape or the like, for example.

(1-2) Twisted Pair Electrical Wire:

As described above, the cable 10 according to the present embodiment can have the two electrical wires 11, that is, the pair of electrical wires 11.

The pair of electrical wires 11 can be twisted together to form the twisted pair electrical wire 110. The pair of electrical wires 11 foaming the twisted pair electrical wire 110 can have the same configuration.

By twisting the two electrical wires 11 having the same configuration to form the twisted pair electrical wire 110, it is possible to make signals transmitted by the electrical wires 11 less susceptible to noise.

(1-3) Dielectric:

(Dielectric Loss Tangent)

The dielectric 12 can be disposed to cover the twisted pair electrical wire 110, as described above.

The dielectric 12 preferably has a dielectric loss tangent (tanδ) greater than 2.5×10⁻⁴, more preferably greater than or equal to 7.0×10⁻⁴, and still more preferably greater than or equal to 2.5×10⁻³.

An upper limit of the dielectric loss tangent of the dielectric 12 is not particularly limited, but is preferably less than or equal to 6.0×10⁻², and more preferably less than or equal to 2.0×10⁻².

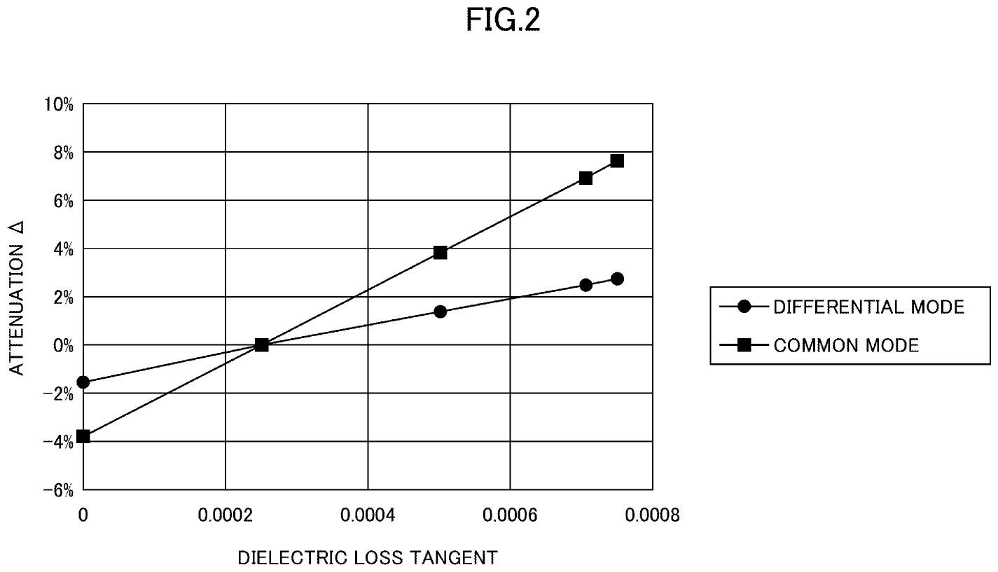

The present inventors studied the extents of the attenuation of the common mode signals and the differential mode signals for the case where the dielectric loss tangent of the dielectric is varied in the cable including the twisted pair electrical wire and the dielectric covering the twisted pair electrical wire. Results of the studies are illustrated in FIG. 2. FIG. 2 is a diagram illustrating an attenuation Δ, that is, a rate of change of the attenuation of the signal in each of the common mode and the differential mode when the dielectric loss tangent of the dielectric is varied with reference to a case where the dielectric loss tangent of the dielectric is 2.5×10⁻⁴ and the attenuation Δ is 0%.

As illustrated in FIG. 2, as the dielectric loss tangent of the dielectric 12 increases, the attenuation increases for both the common mode signals and the differential mode signals. However, the rate of change of the attenuation associated with the variation of the dielectric loss tangent is greater for the common mode signals than for the differential mode signals.

It may be regarded that a difference between the extents of the attenuation due to the variation of the dielectric loss tangent of the dielectric 12 is caused by a difference between distributions of electromagnetic fields inside the cable 10 for the differential mode signals and the common mode signals. More particularly, in the case of the differential mode signals, the electromagnetic field is mainly distributed between the electrical wires 11. On the other hand, in the case of the common mode signals, the electromagnetic field is widely distributed even into a region of the dielectric 12. For this reason, it may be regarded that the common mode signals are more severely affected by an environment of the dielectric 12 when compared to the differential mode signals, and that by increasing the dielectric loss tangent of the dielectric 12, the common mode signals are more easily attenuated when compared to the differential mode signals.

According to the studies conducted by the present inventors, it was found that, by setting the dielectric loss tangent of the dielectric 12 to a value greater than 2.5×10⁻⁴, the extent of the attenuation of the common mode signals can be particularly increased, and the common mode signals can be selectively attenuated.

Hence, by setting the dielectric loss tangent of the dielectric 12 to the value greater than 2.5×10⁻⁴, it is possible to reduce a signal generated by the mode conversion, particularly the common mode signal, and sufficiently reduce the conversion from the common mode to the differential mode.

In addition, the dielectric loss tangent of the dielectric 12 is preferably greater than a dielectric loss tangent of the insulator 112 included in the electrical wire 11.

As described above, by increasing the dielectric loss tangent of the dielectric 12, the conversion from the common mode to the differential mode can be reduced.

On the other hand, the transmission loss of the electrical wires 11 has a positive correlation with a signal frequency and the dielectric loss tangent of the insulator 112 of the electrical wire 11. For this reason, in order to increase a signal transmission speed to perform a high-speed signal transmission, the dielectric loss tangent of the insulator 112 is preferably reduced.

Accordingly, by making the dielectric loss tangent of the dielectric 12 greater than the dielectric loss tangent of the insulator 112 as described above, it is possible to reduce the conversion from the common mode to the differential mode, while reducing the transmission loss of the electrical wires 11 included in the twisted pair electrical wire 110.

(Material)

A material used for the dielectric 12 is not particularly limited. The material used for the dielectric 12 can be selected so as to have the dielectric loss tangent described above.

The dielectric 12 can include a resin material. The resin material included in the dielectric 12 is not particularly limited, but a polyolefin-based resin can be suitably used as the resin material. The polyolefin-based resin can be the same as the polyolefin-based resin described above used for the insulator 112, and a description thereof will be omitted.

The resin material included in the dielectric 12 can be cross-linked, or not cross-linked.

In addition to the resin material, the dielectric 12 can include an additive, such as a flame retardant, a flame retardant assistant, an antioxidant, a lubricant, a coloring agent, a reflection imparting agent, a masking agent, a processing stabilizer, a plasticizer, or the like.

The dielectric 12 includes the resin material and the additive, for example, and the dielectric loss tangent thereof can be set to a desired value by selecting a content of the additive.

(Size)

A shape and a size of the dielectric 12 are not particularly limited. The dielectric 12 can have a circular shape in a cross section perpendicular to the longitudinal direction, as illustrated in FIG. 1. The term “circular shape” as used herein does not have a geometrically strict meaning, and includes circular shapes other than a perfect circle, such as an oval shape or the like, for example.

(1-4) Arbitrary Member that can be Included in Cable of the Present Embodiment:

(Jacket)

The cable 10 according to the present embodiment can include a jacket 14 disposed on an outer side of the dielectric 12. The jacket 14 can be disposed so as to make direct contact with the dielectric 12, or can be disposed so that a shielding layer 13, which will be described later, is arranged between the jacket 14 and the dielectric 12.

In a case where the cable 10 according to the present embodiment includes the jacket 14, it is possible to protect the twisted pair electrical wire 110 or the like disposed inside the cable 10, and to improve the durability of the cable 10.

A material used for the jacket 14 is not particularly limited. The jacket 14 can include a resin material. The resin material included in the jacket 14 is not particularly limited, and for example, one or more kinds of resins selected from a polyolefin-based resin, a polyurethane resin (PU), and a polyvinyl chloride resin (PVC) can be suitably used as the resin material. The polyolefin-based resin can be the same as the polyolefin-based resin described above used for the insulator 112, and a description thereof will be omitted.

The resin material included in the jacket 14 can be cross-linked, or not cross-linked.

In addition to the resin material, the jacket 14 can include an additive, such as a flame retardant, a flame retardant assistant, an antioxidant, a lubricant, a coloring agent, a reflection imparting agent, a masking agent, a processing stabilizer, a plasticizer, or the like.

(1-5) Shielding Layer:

The cable 10 according to the present embodiment can include the shielding layer 13 made of a metal, disposed between the dielectric 12 and the jacket 14.

In a case where the cable 10 includes the shielding layer 13, it is possible to shield external noise from entering the electrical wires 11, and to shield noise from being emitted to the outside from the electrical wires 11.

The shielding layer 13 can be formed by a single shielding layer, or formed by two or more shielding layers.

The shielding layer 13 may be configured to include a metallic element wire, for example. The shielding layer 13 can be configured to include a metallic film, for example. In a case where the shielding layer 13 is formed by two or more layers as described above, each layer may have a different configuration.

Hereinafter, a configuration for a case where the shielding layer 13 includes the metallic element wire, and a configuration for a case where the shielding layer 13 includes the metallic film, will be described.

(Shielding Layer Including Metallic Element Wire)

The shielding layer 13 can include the metallic element wire made of a metallic material, such as copper, copper alloys, aluminum, aluminum alloys, or the like, or a material obtained by plating a surface of any of such metallic materials. An annealed copper wire, a hard drawn copper wire, or the like can also be used for the metallic element wire. The surface of the metallic element wire can be plated as described above, and examples of the plating include silver plating and tin plating. For this reason, a silver plated annealed copper wire, a tin plated annealed copper wire, or the like can be used as the metallic element wire.

As described above, in the case where the shielding layer 13 includes the metallic element wire, the shielding layer 13 can be formed by longitudinally lapping or braiding the metallic element wire.

(Shielding Layer Including Metallic Film)

The shielding layer 13 can include the metallic film, for example.

In the case where the shielding layer 13 includes the metallic film, the shielding layer 13 can be formed solely of the metallic film, or formed of a composite material having the metallic film laminated on a base.

In a case where the shielding layer 13 includes the composite material having the base and the metallic film, the shielding layer 13 can include a polymer film as the base, and a metallic film disposed on a surface of the base.

A method of disposing the metallic film on the surface of the base is not particularly limited, and the metallic film can be formed and fixed on the base by vapor deposition, plating, bonding, or the like. In the case where the shielding layer 13 includes the composite material having the base and the metallic film, it is possible to increase a mechanical strength and improve handleability, when compared to the case where the shielding layer includes solely the metallic film. By increasing the mechanical strength of the shielding layer 13, the shielding layer 13 is less likely to be damaged when the cable 10 is bent, and it is thus possible to also obtain an effect of increasing a flexing resistance of the cable 10.

In the case where the shielding layer 13 includes the metallic film as described above, a material used for the metallic film is not particularly limited, and examples thereof include metallic materials, such as copper, copper alloys, aluminum, aluminum alloys, or the like. The metallic film may be famed by a film made of a single kind of metal, or may be famed by a laminate of films made of two or more kinds of metals. A material other than metal, such as an organic material or the like, can be disposed on a surface of the metallic film, as required, to form a protective film or the like.

As described above, the shielding layer 13 can include the metallic film and the base. A material used for the base is not particularly limited. Examples of the material used for the base include polyester resins, such as polyethylene terephthalate (PET) or the like, polyolefin-based resins, such as polypropylene or the like, and vinyl resins, such as polyvinyl chloride or the like, for example. The base can include various additives in addition to the various polymer materials. From a viewpoint of excellent mechanical strength, flexibility, or the like, the polyester resin can be suitably used as the polymer material.

The shielding layer 13 can include one or more kinds selected from the longitudinally lapped or braided metallic element wire, and the metallic film, which are described above.

(2) Application of Cable:

The application of the cable 10 according to the present embodiment is not particularly limited, and the cable 10 can be used in various applications.

In recent years, automobiles have become more digitized, and a large number of communication cables are used. On the other hand, an environment in an interior of the automobile includes considerable noise. For this reason, from a viewpoint of reducing generation of communication errors and stabilizing the communication, it is particularly required that the conversion from the common mode to the differential mode can be reduced in the cables for automobile use. As described above, in the cable 10 according to the present embodiment, the conversion from the common mode to the differential mode can be reduced. Hence, the cable 10 according to the present embodiment can be suitably used particularly as the cable for automobile use.

[Exemplary Implementations]

Hereinafter, the present invention will be described with reference to specific exemplary implementations, but the present invention is not limited to these exemplary implementations.

(Evaluation Method)

First, a method for evaluating cables manufactured in the following experimental examples will be described.

(1) Outer Diameters of Insulator 112 and Dielectric 12:

An outer diameter D112 of the insulator 112, and an outer diameter D12 of the dielectric 12, were measured and calculated by the following procedure.

More particularly, in the case of the outer diameter D112 of the insulator 112, an outer diameter of the insulator 112 was measured by a micrometer along two mutually orthogonal diameters of the wire 11 in an arbitrary cross section perpendicular to the longitudinal direction of the cable 10. An average value of the two measured outer diameters of the insulator 112 was determined as the outer diameter D112 of the insulator 112 of the wire 11.

The outer diameter D12 of the dielectric 12 was measured and calculated by the same procedure used to measure and calculate the outer diameter D112 of the insulator 112, except that a measurement target is the dielectric 12 and not the insulator 112.

(2) Dielectric Loss Tangent:

A raw material used for the dielectric 12 in each of the following experimental examples was press-molded to form a sheet sample. The press-molding was performed under conditions of preheating at a temperature of 180° C. for 5 minutes, thereafter further press-molding at this temperature, and holding for 5 minutes. A dielectric loss tangent (tanδ) of the obtained sheet sample for a case where a high-frequency electric field (that is, a radiofrequency field) having a frequency of 10 GHz is applied, was measured according to a method in conformance with JIS R 1641 (2007). The measurement was performed 3 times, and an average value of the 3 measurements was determined as the dielectric loss tangent of the dielectric 12.

(3) LCTL (Sdc21):

A differential conversion loss (Sdc21) indicating a transmission mode conversion characteristic (LCTL) was evaluated by the following procedure.

The LCTL is a short name for “longitudinal conversion transfer loss”.

The Sdc21 represents an amount of the common mode signals converted into the differential mode signals during a transmission.

First, a network analyzer was connected to a cable having a length of 10 m and manufactured in each of the following experimental examples, and the Sdc21 was calculated from a ratio of a common mode signal and a differential mode signal at 600 MHz when the common mode signal is transmitted. The measurement was performed in accordance with “Channel and Component Requirements for 1000BASE-T1 Link Segment Type A (STP)” issued by OPEN ALLIANCE.

(Sample Manufacturing Conditions and Evaluation Results)

Cables of experimental example 1 through experimental example 3 were manufactured and subjected to the evaluation described above. The experimental example 1 corresponds to a comparative example, and the experimental example 2 and the experimental example 3 correspond to exemplary implementations.

### Experimental Example 1

In the experimental example 1, the cable having the same cross sectional configuration as that of the cable 10 illustrated in FIG. 1 in the cross section perpendicular to the longitudinal direction, except for the shielding layer 13 and the jacket 14 that are not provided, was manufactured.

Two electrical wires 11, each including a conductor and an insulator having a configuration illustrated in Table 1, were twisted together to form a twisted pair electrical wire 110. A stranded wire having the number of conductor element wires illustrated in Table 1 are twisted together, is used as the conductor. In Table 1, PP represents polypropylene.

Polypropylene, that is the material illustrated in Table 1, was supplied to an extrusion molding machine and molded to form the dielectric 12, so as to cover the outer surface of the twisted pair electrical wire 110. The dielectric 12 had a circular shape in a cross section perpendicular to the longitudinal direction.

The evaluation results of the experimental example 1 are illustrated in Table 1.

### Experimental Examples 2 and 3

When forming the dielectric 12, a mixture of polypropylene and a metal hydroxide that is a flame retardant, illustrated in Table 1, was supplied to the extrusion molding machine. A mixing ratio of the mixture was adjusted in advance, so as to obtain a desired dielectric loss tangent (tanδ). The cables were manufactured and evaluated under the same conditions as the experimental example 1, except for the points noted above.

The evaluation results of the experimental example 2 and the experimental example 3 are illustrated in Table 1.

TABLE 1

| | | | | | Experi- | Experi- | Experi- |
|---|---|---|---|---|---|---|---|
| | | | | | mental | mental | mental |
| | | | | | exam- | exam- | exam- |
| | | | | | ple 1 | ple 2 | ple 3 |
| Config- | Twisted | Conductor | Material | — | Tin plated annealed copper | | |
| uration | Pair | | | | wire | | |
| of | Electrical | | Element | (mm) | 0.156 | | |
| Cable | Wire | | wire | | | | |
| | (Electrical | | diameter | | | | |
| | Wires) | | Number of | (conductors) | 7 | | |
| | | | conductors | | | | |
| | | Insulator | Material | — | PP | | |
| | | | Outer | (mm) | 0.95 | | |
| | | | diameter | | | | |
| | Dielectric | | Material | — | PP | PP & | PP & |
| | | | | | | Flame | Flame |
| | | | | | | retardant | retardant |
| | | | Outer | (mm) | 3 | | |
| | | | diameter | | | | |
| | | | tan δ | — | 2.5 × | 7.0 × | 2.5 × |
| | | | | | 10⁻⁴ | 10⁻⁴ | 10⁻³ |
| Eval- | Sdc21(600 MHz) | | | (dB) | −35 | −45 | 50 |
| uation | | | | | | | |
| Result | | | | | | | |

According to the present disclosure, it is possible to provide a cable capable of reducing conversion from the common mode to the differential mode.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A cable comprising:
a twisted pair electrical wire having a pair of electrical wires twisted together; and
a dielectric covering the twisted pair electrical wire,
wherein a dielectric loss tangent of the dielectric is greater than 2.5×10⁻⁴.

2. The cable as claimed in claim 1, further comprising:
a jacket disposed on an outer side of the dielectric.

3. The cable as claimed in claim 2, further comprising:
a shielding layer made of a metal, disposed between the dielectric and the jacket.

4. The cable as claimed in claim 2, wherein
each of the pair of electrical wires includes a conductor, and an insulator covering the conductor, and
the dielectric loss tangent of the dielectric is greater than a dielectric loss tangent of the insulator.

5. The cable as claimed in claim 1, wherein
each of the pair of electrical wires includes a conductor, and an insulator covering the conductor, and
the dielectric loss tangent of the dielectric is greater than a dielectric loss tangent of the insulator.
